(19) United States
(12) Patent Application Publication
(10) Pub. No.: US 2006/0285157 A1
(43) Pub. Date: Dec. 21, 2006

(54) Host device and image forming device and printing control method thereof

(75) Inventors: Mi-kyung Choi, Suwon-si (KR); Young-dal Oh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/454,941

(22) Filed: Jun. 19, 2006

(30) Foreign Application Priority Data
Jun. 20, 2005 (KR) 2005-52982
Jun. 2, 2006 (KR) 2006-49633

(51) Int. Cl. G06F 3/12

(52) U.S. Cl. 358/1.15

(57) ABSTRACT

A printing system, printing method, a host device and an image forming device are provided. The printing system includes: an image forming device to print a test pattern per each object to measure and transmit a required time to print the test pattern per each object; and a host device, the host device to receive the required time to print the test pattern per each object and compare the required time to print the test pattern per each object with a pre-set reference time, to determine an object to be changed among objects included in the data, to change the determined object to be changed to another object that requires less time to print than the reference time, and to produce the print data based on the changed object to transmit to the image forming device. Therefore, an optimum printing speed can be provided.

### CROSS-REFERENCE TO RELATED APPLICATIONS

This application claims the benefit of Korean Patent Application No. 2005-52982 filed on Jun. 20, 2005, and Korean Patent Application No. 2006-49633 filed on Jun. 2, 2006 in the Korean Intellectual Property Office, the disclosures of which are incorporated herein by reference.

### BACKGROUND OF THE INVENTION

1. Field of the Invention

Aspects of the invention relate to a host device and image forming device, and relate to a printing control method thereof. More particularly, aspects of the invention relate to a host device and an image forming device which allow a fast printing speed, and a printing control method thereof.

2. Description of the Related Art

Generally, a printing system includes a host transmitting print data to give print commands, and an image forming device, such as a printer, to print the print data received from the host. In the initial stage, one host is connected to one image forming device to print the print data. However, one host can be selectively connected to a plurality of image forming devices, such as by being connected over a network.

A printing process of a printing system will be briefly explained with the plurality of image forming devices connected over network. First, as application programs of the host give print commands on the data to print, the Windows Graphic Device Interface (GDI) transmits the information on the data to a driver. The driver produces print data, such as a vector command, an image command, and a font command, respectively corresponding to each object by using the information on the data received from the Windows GDI. Then, the driver transmits the produced print data to one image forming device to perform the printing.

During the printing, the plurality of image forming devices has various printing speeds to print the print data in view of the features of each image forming device. Additionally, the plurality of image forming devices has various printing speeds for each object, such as font, image, and vector graphic, included in the print data received from the host.

As described above, the driver produces print data by directly using the information on the data received from the Windows GDI without considering various printing speeds for each object of the image forming device. Accordingly, where an image forming device is used which has a slow speed to print the object included in the data, a fast printing speed can not be expected.

### SUMMARY OF THE INVENTION

Accordingly, aspects of the present invention are to promote solving the above and/or other problems and/or disadvantages and to provide the below described and/or other advantages. Therefore, several embodiments and aspects of the invention provide a host device an image forming device, and a printing control method. According to one aspect, among aspects, of the invention, the host device selects one of a plurality of image forming devices that can process print data with a fast speed. According to another aspect, among aspects of the invention, the host device provides print data with an object having the fastest speed so that an optimal printing speed can be provided.

According to an embodiment and aspects of the invention, there is provided a host device to control printing of an image forming device. The host device includes: an application program part to provide a print command on print data; an image forming device interface part to provide an interface with the image forming device; a driver part to request of the image forming device a required time to print a test pattern per each object, via the image forming device interface part, to compare the required time to print the test pattern per each object with a pre-set reference time, and to determine each object to be changed to another object as a determined object included in the print data based upon the required time to print the test pattern per each object compared to the pre-set reference time; and an object change part to change each determined object to another object that requires less time to print than the pre-set reference time. The driver part produces the print data based on each changed object or each unchanged object or both the changed and unchanged objects of the print data to transmit, via the image forming device interface part, to the image forming device.

The pre-set reference time can be set according to one or more of a reference speed of the image forming device, a degree of complication of the test pattern per each object, or a data capacity of the test pattern per each object.

The driver part also can transmit the test pattern per each object, via the image forming device interface part, to the image forming device, where requesting a required time to print the test pattern per each object.

The object change part can be a Windows graphic device interface (GDI).

According to an embodiment and aspects of the invention, there is also provided a printing control method of an image forming device. The method includes: operations of requesting of the image forming device a required time to print a test pattern per each object where a print command is provided on print data; receiving the required time to print the test pattern per each object from the image forming device; comparing the received required time to print the test pattern per each object with a pre-set reference time to determine an object to be changed to another object as a determined object included in the print data based upon the required time to print the test pattern per each object compared to the pre-set reference time; changing each determined object to be changed to another object that requires less time to print than the pre-set reference time; and producing the print data based on each changed object or each unchanged object or both the changed and unchanged objects of the print data to transmit to the image forming device.

The requesting the required time to print the test pattern per each object can include also transmitting the test pattern per each object to the image forming device.

According to an embodiment and aspects of the invention, there is also provided an image forming device that includes: a host interface part to receive a request signal to request a required time to print a test pattern per each object from a host; a print part to print the test pattern per each object; and a control part to measure the required time to print the test pattern per each object by the print part and to control the host interface part to transmit the measured required time to print the test pattern per each object to the host.

The image forming device can further include, according to aspects of the invention, a storage part to store the test pattern per each object.

The host interface part, according to aspects of the invention, can receive the test pattern per each object together with the request signal to request the required time to print the test pattern per each object.

According to an embodiment and aspects of the invention, there is further provided a host device to control printing of a plurality of image forming devices. The host device includes: an application program part to provide a print command on print data; an image forming device interface part to provide an interface with the plurality of the image forming devices; a driver part to recognize a component ratio per each object included in the print data, to calculate, or determine, an expected processing time of the print data for each of the plurality of image forming devices corresponding to a required time to print test patterns per each object of the plurality of image forming devices, to select one of the plurality of image forming devices that has the shortest expected processing time, and to compare the required time to print the test pattern per each object with a pre-set reference time to determine each object to be changed to another object as a determined object included in the print data based upon the required time to print the test pattern per each object compared to the pre-set reference time; and an object change part to change each determined object to another object that requires less time to print than the pre-set reference time. The driver part produces the print data based on each changed object of the print data to transmit, via the image forming device interface part, to the selected image forming device.

The driver part, according to aspects of the invention, can transmit the test patterns per each object, via the image forming device interface part, to the plurality of the image forming devices, and receive a required time to print the test patterns per each object from the plurality of the image forming devices.

The host device, according to aspects of the invention, can further include a storage part to store a table regarding a required time to print the test patterns per each object of the plurality of image forming devices. The driver part can, according to aspects of the invention, update the table of the storage part by the received required time to print the test patterns per each object.

The pre-set reference time, according to aspects of the invention, can be set according to one or more of a reference speed of the image forming device, a degree of complication of the test pattern per each object, or a data capacity of the test pattern per each object.

Also, according to aspects of the invention, the object change part can include a Windows graphic device interface (GDI).

According to an embodiment and aspects of the invention, there is also provided a printing method of a plurality of image forming devices. The printing method includes: recognizing a component ratio per each object included in print data where a print command is provided on the print data; calculating, or determining, an expected processing time of the print data for each of the plurality of image forming devices corresponding to a required time to print test patterns per each object of the plurality of image forming devices; selecting one of the plurality of image forming devices that has the shortest expected processing time; comparing the required time to print the test pattern per each object with a pre-set reference time to determine each object to be changed to another object as a determined object included in the print data based upon the required time to print the test pattern per each object compared to the pre-set reference time; changing each determined object to another object that requires less time to print than the pre-set reference time; and producing the print data based on each changed object of the print data to transmit to the selected image forming device.

The printing method, according to aspects of the invention, can further include operations of transmitting the test patterns per each object to the plurality of the image forming devices, and receiving a required time to print the test patterns per each object from the plurality of the image forming devices.

The printing method, according to aspects of the invention, can further include an operation of storing the received required time to print the test patterns per each object into a table regarding a required time to print the test patterns per each object of the plurality of image forming devices.

The pre-set reference time, according to aspects of the invention, can be set according to one or more of a reference speed of the image forming device, a degree of complication of the test pattern per each object, or a data capacity of the test pattern per each object.

Additional aspects and/or advantages of the invention are set forth in or are evident from the description which follows, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a printing system according to an embodiment of the invention;

FIG. 2 illustrates a block diagram of a host device according to an embodiment of the invention;

FIG. 3 is a block diagram of an image forming device according to an embodiment of the invention;

FIG. 4 is a flowchart of a printing control method of a host device according to an embodiment of the invention; and

FIG. 5 is a flowchart of a printing method of an image forming device according to an embodiment of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain the invention by referring to the figures.

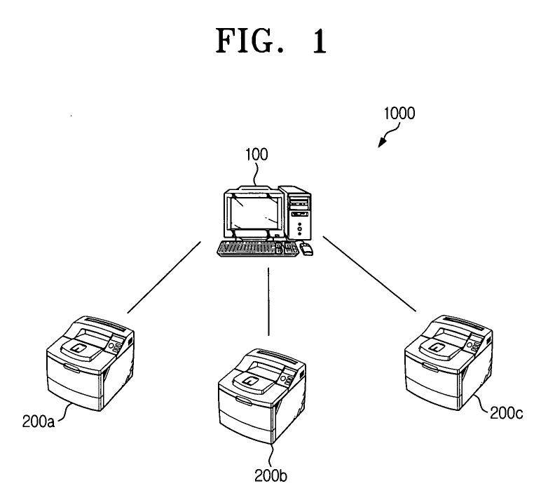

FIG. 1 illustrates a printing system 1000 according to an embodiment of the invention. Referring to FIG. 1, the printing system 1000 according to an embodiment and aspects of the invention includes a host device 100 and a plurality of image forming devices 200a through 200c. In FIG. 1, three image forming devices 200a through 200c are exemplified and illustrated, but the number of the image forming devices 200a through 200c, which are connected to or communicate with the host device 100, is not limited to the three image forming devices as shown in FIG. 1. However, the host device 100 can be connected to or communicate with any suitable number of image forming devices or a single image forming device.

The host device 100 transmits print data to the plurality of image forming devices 200, such as image forming devices 200a through 200c, which are connected to or communicate with the host device 100, and controls the image forming devices 200a through 200c to perform printing. The host device 100 can determine one of the plurality of image forming devices 200a through 200c that has the shortest expected processing time and control the determined image forming device to perform printing.

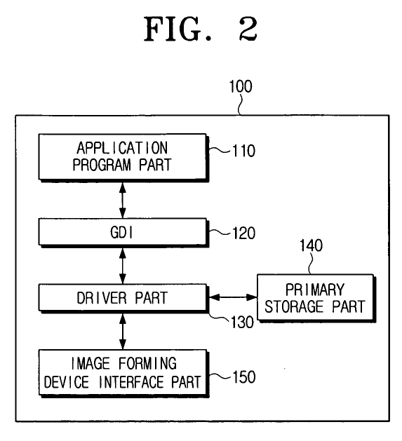

The host device 100 can control the printing to be performed by print data generated with an object or objects having less required time to print based on a required time to print per each object included in print data. In this regard and by way of example, the host device 100 is further described with reference to FIG. 2. The plurality of image forming devices 200a through 200c are connected or communicate with the host device 100, and receive test patterns per each object and print data from the host device 100 to perform printing.

The plurality of image forming devices 200a through 200c each typically have a different printing speed depending on their design and installed software. For example, if the printing speed of image forming device A (200a) is 19 PPM and the printing speed of image forming device B (200b) is 21 PPM, the image forming device B (200b) is faster than the image forming device A (200a) in its designed printing speed, but the image forming device A (200a) can be faster than the image forming device B (200b) in an actual printing speed.

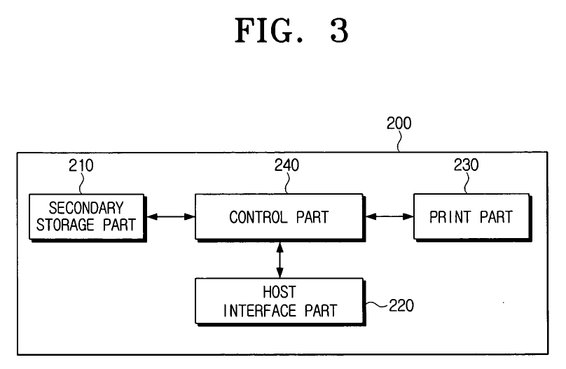

The printing speed of the plurality of image forming devices 200a through 200c, which are affected by the design and software, can, according to aspects of the invention, be checked through an actual printing, for example. The image forming devices 200, such as image forming devices 200a through 200c, are further described with reference to FIG. 3.

FIG. 2 is a block diagram of the host device 100 according to an example embodiment and aspects of the invention. Referring to FIG. 2, the host device 100 includes an application program part 110, an object change part 120, a driver part 130, a primary storage part 140, and an image forming device interface part 150. The host device 100 can be a suitable processing device, such as a general computer, processor, microprocessor or application specific integrated circuit (ASIC), with associated memory and software or programming to carry out the functions of the host device 100, and the host device 100 is connected to or communicates with the image forming device 200, such as the image forming devices 200a through 200c, by a suitable connection method or communication method, such as by a wired and/or or wireless communication or connection method.

The application program part 110 produces data or reads the pre-produced data to give print commands on data according to a user's request. The data includes a plurality of objects, such as font, image, and/or vector graphic objects. As the driver part 130 determines the object to be changed, the object change part 120 changes the object to another object that requires less time to print than a reference time; and the object to be changed can be a single object or a plurality of objects of the same or different type objects. The object change part 120 can be a Windows Graphic Device Interface (GDI), or other suitable graphic device interface (GDI), for example.

The object change part (GDI) 120 is, by way of example, a type of Microsoft WINDOWS operation system, such as used for a computer operation system, and provides an interface between the application program part 110 and the driver part 130. For example, the object change part (GDI) 120 transmits to the driver part 130 the print data and the print command received from the application program part 110.

The driver part 130 is a general driver program that converts print data into the print data readable by the plurality of image forming devices 200a through 200c if a print command is received from the application program part 110. If the print command is received from the application program part 110, the driver part 130 recognizes a component ratio per each object included in the print data. For example, the component ratio can be font 20%, image 30%, and vector graphic 50% in the print data, or other suitable combinations thereof.

The plurality of image forming devices 200a through 200c determine the required time to print test patterns per each object, such as by referring to a table pre-stored in the primary storage part 140, or, alternatively, using the required time to print received from the plurality of image forming devices 200a through 200c by transmitting test patterns per each object to the plurality of image forming devices 200a through 200c, for example.

The driver part 130 calculates, or determines, an expected processing time of the print data for each of the plurality of image forming devices 200a through 200c by a component ratio per each object included in the print data and the required time to print test patterns per each object of the plurality of image forming devices 200a through 200c. The driver part 130 calculates, or determines, the expected processing time of the print data for each of the plurality of image forming devices 200a through 200c and selects an expected processing time that has the shortest expected processing time to select or determine an image forming device to perform an actual printing.

In response to receiving the print data and the print command via the object change part (GDI) 120 from the application part 110, the driver part 130 requests of the image forming device 200, such as the image forming devices 200a, 200b and/or 200c, via the image forming device interface part 150, the required time to print test patterns per each object corresponding to the print data. Where the test patterns per each object are stored by the primary storage part 140, such as a read only memory (ROM), a random access memory (RAM) or other suitable memory or storage media, the driver part 130 transmits the test patterns per each object when requesting of the image forming device 200 the required time to print the test patterns per each object.

In response to selecting an image forming device 200, such as from image forming devices 200a, 200b and/or 200c, to perform an actual printing, or in response to receiving the required time to print the test patterns per each object via the image forming device interface part 150 from the corresponding image forming device 200, the driver part 130 compares the pre-set reference time with the received required time to print the test patterns per each object.

According to the comparison result, the driver part 130 determines the object to be changed among objects included in the print data. In this regard and by way of example, where the required time to print the test patterns per each object is in excess of, or greater than, the reference time, the driver part 130 determines the object that requires more time than the reference time to print the test pattern of the object be changed to another object as a determined object.

When the object is to be changed according to the comparison result, the driver part 130 determines the object to be changed to transmit to the object change part (GDI) 120, and receives a changed object from the object change part (GDI) 120 to produce the print data readable by the image forming device 200. Additionally, the driver part 130 transmits the produced print data via the image forming device interface part 150 to the image forming device 200 that is selected to perform an actual printing.

Where requesting of the plurality of the image forming devices 200, such as image forming devices 200a through 200c, the required time to print test patterns per each object, the primary storage part 140 can store the test patterns per each object to be transmitted to the plurality of the image forming devices 200a through 200c. The primary storage part 140 stores a table regarding the required time to print test patterns per each object of the plurality of image forming devices 200a through 200c. The table stored in the primary storage part 140 can be updated, if necessary, such as by a user's selection. The primary storage part 140 stores the reference time for the driver part 130 to determine an object to be changed. The reference time is typically pre-set per each object, and it is understood that the reference time can be changed or can vary, such as depending upon the use or application, for example.

The reference time per each object can be set in view of a reference speed, such as pages per minute (PPM), of the image forming device 200. In this regard and by way of example, the reference time can be set according to one or more of a general maximum printing speed, or a reference speed, of the image forming device 200, the degree of complication of test patterns per each object, and/or a data capacity of the test patterns per each object.

The image forming device interface part 150, as a suitable interface for wired and/or wireless communication or connection, is connectable to, or communicates with, the image forming device 200 and provides an interface between the host device 100 and the image forming device 200. According to aspects of the invention, the host device 100 transmits the print data and print command via the image forming device interface part 150 to the image forming device 200, and the image forming device 200 transmits the required time to print the test patterns per each object via the image forming device interface part 150.

FIG. 3 illustrates a block diagram of the image forming device 200, such as the image forming devices 200a through 200c, according to an embodiment and aspects of the invention. Referring to FIG. 3, the image forming device 200 includes a secondary storage part 210, a host interface part 220, a print part 230, and a control part 240. The image forming device 200 is connected to the host, i.e., the host device 100, by a suitable connection method or communication method, such as by a wired and/or wireless communication or connection method.

The image forming device 200 has a common structure as the plurality of image forming devices 200a through 200c which are illustrated in FIG. 1. Accordingly, the image forming device 200 of FIG. 3 is one of, or representative of, the plurality of image forming devices 200a through 200c.

The secondary storage part 210 includes a non-volatile memory and a volatile memory, such as a read only memory (ROM), a random access memory (RAM) or other suitable memory or storage media. Various control programs to implement functions of the image forming device 200 are stored to the non-volatile memory, and data generated in the process of performing the programs of the control part 240 is temporarily stored to the volatile memory, which can also be stored in the non-volatile memory, of the secondary storage part 210. The secondary storage part 210 can store the test patterns per each object which are to be transmitted to the print part 230 under the control of the control part 240, where the host device 100 requests the required time to print the test patterns per each object.

The host interface part 220, as a suitable interface for wired and/or wireless communication or connection, is connectable to, or communicates with, the host device 100 and provides an interface between the image forming device 200 and the host device 100. The host interface part 220 can transmit the operation status of the image forming device 200 to the host device 100, and can transmit the request signal to the control part 240 in response to receiving the request signal to request the required time to print the test patterns per each object from the host device 100.

The print part 230, such as a suitable printer, outputs the test patterns per each object under the control of the control part 240, and the print data received via the host interface part 220 from the host device 100. According to an aspect, among aspects, of the invention, since the object(s) included in the data is/are changed to another object with fast printing speeds by the object change part (GDI) 120 of the host device 100, the printing speed of the print part 230 can be improved.

The control part 240 controls general functions of the image forming device 200, and, more specifically, controls output and input of signals among the secondary storage part 210, the print part 230, and the host interface part 220. The control part 240 can be a suitable processing device, such as a processor, microprocessor or application specific integrated circuit (ASIC), with associated memory and software or programming to carry out the functions of the image forming device 200.

In response to receiving the request signal to request the required time to print the test patterns per each object via the host interface part 220, the control part 240 controls the print part 230 to print the test patterns per each object. The test patterns per each object can be test patterns pre-stored in the secondary storage part 210, or test patterns input with the request signal to request the required time to print the test patterns per each object.

The control part 240 measures each required time to print the test patterns per each object of the print part 230. The control part 240 transmits each measured required time to print the test patterns per each object, via the host interface part 220, to the host device 100. Thus, the control part 240 transmits, or communicates, the required time to print the test patterns per each object to the host device 100. Then, in response to receiving the print data via the host interface part 220, the control part 240 controls the print part 230 to print the print data.

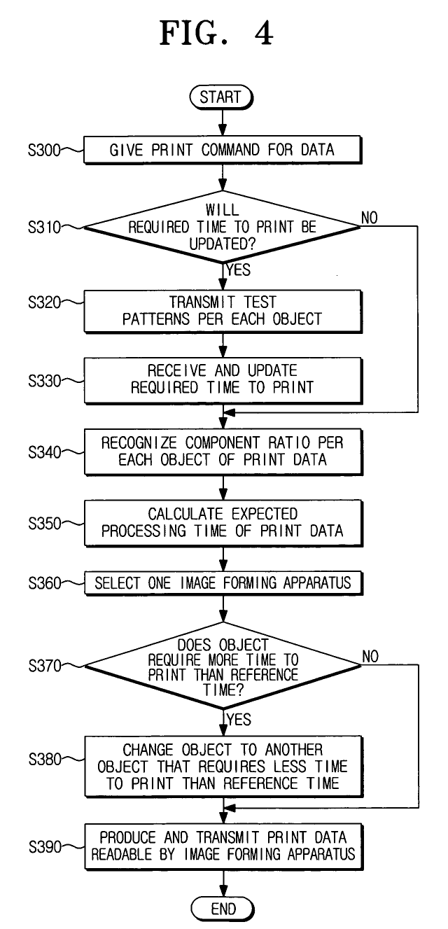

FIG. 4 is a flowchart of a printing control method of the host device 100 according to an embodiment and aspects of the invention. According to a user's operation, the application program part 110 produces the data and provides, or transmits, the print command for the produced data via the object change part 120, such as a GDI, to the driver part 130 (operation S300).

In response to the received print command, the driver part 130 can allow a user to select whether the required time to print is updated for one or more image forming devices, such as image forming devices 200a through 200c. If a user tries to update the required time to print (operation S310-YES), the driver part 130 transmits, or provides, the test pattern per each object pre-stored in the primary storage part 140 to one or a plurality of the image forming devices, such as the image forming devices 200a through 200c, (operation S320), otherwise the operation proceeds to operation S 340 (operation S310-NO).

In response to the received required time to print from the plurality of image forming devices 200a through 200c, the driver part 130 updates the table regarding the required time to print the test patterns per each object of the one or the plurality of image forming devices stored in the primary storage part 140 (operation S330).

The driver part 130 recognizes the component ratio per each object of the print data (operation S340), and calculates, or determines, the expected processing time of the print data for one or a plurality of image forming devices, such as image forming devices 200a through 200c, such as based on the recognized component ratio per each object and the updated table regarding the required time to print (operation S350).

Where the driver part 130 determines the expected processing time of the print data for a plurality of image forming devices, the driver part 130 selects one among the plurality of image forming devices, such as image forming devices 200a through 200c, that has the shortest required time to print based on the calculated, or determined, expected processing time of the print data (operation S360). The driver part 130 compares the required time to print the test patterns per each object, received via the image forming device interface part 150, with the pre-set, or predetermined, reference time so as to determine whether there exists an object to be changed among objects in the data, based upon a comparison of the required time to print the test patterns per object being greater than the pre-set, or predetermined, reference time (operation S370).

In operation S370 (operation S370-YES), where the driver part 130 determines that there exists one or more objects to be changed, the driver part 130 transmits the object(s) to be changed to the object change part (GDI) 120. The object change part (GDI) 120 changes the object(s) to be changed received from the driver part 130 to another object that requires less time to print than the pre-set, or predetermined, reference time and provides, or transmits, the changed object(s) to the driver part 130 (operation S380), otherwise the operation proceeds to operation S390 (operation S370-NO).

Where one or a plurality of objects in the data are all changed to another object(s) that require(s) less time to print than the pre-set, or predetermined, reference time by the object change part (GDI) 120, the driver part 130 produces the print data based on the changed object(s) and transmits the print data to the image forming device 200 (operation S390). However, where there is no object in the data that requires more time to print than the pre-set, or predetermined, reference time, the driver part 130 produces the print data based on the present, or unchanged, objects without changing the objects and transmits the print data to the image forming device 200 (operation S390).

As described above, when the host device 100 is connected to a plurality of image forming devices, such as image forming devices 200a through 200c, the operations S300 through S390 illustrated in FIG. 4 can be performed, according to aspects of the invention. Accordingly, the printing can be performed by one among the plurality of image forming devices 200a through 200c that has the shortest required time to print. However, if the host device 100 is connected to one image forming device 200, all or part of the operations S300 through S360 can be omitted, according to aspects of the invention. Accordingly, the printing system including one image forming device 200 can also provide a fast printing speed.

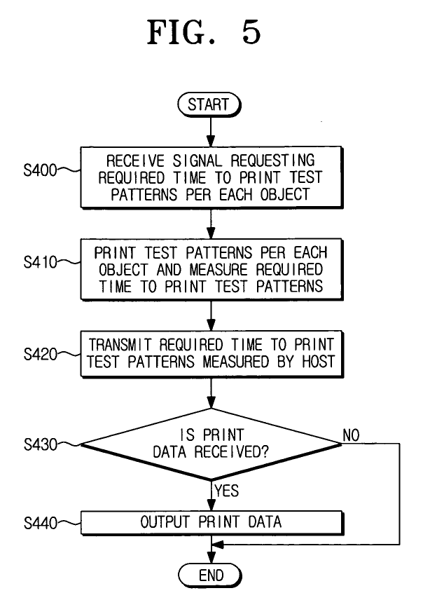

FIG. 5 is a flowchart of a printing method of the image forming device 200, such as the image forming devices 200a, 200b and 200c, according to an embodiment and aspects of the invention. The printing method of the image forming device 200 will be explained with reference to FIGS. 1 through 5. The image forming device 200 receives the request signal to request the required time to print test patterns per each object via the host interface part 220 from the host device 100. Also, the image forming device 200 can receive, together with the request signal, the test pattern per each object (operation S400).

In response to receiving the request signal to request the required time to print the test pattern per each object, via the host interface part 220, the control part 240 controls the print part 230 to print the test patterns per each object. Where the print part 230 prints the test patterns per each object, the control part 240 measures the required time to print the test pattern per each object (operation S410). The control part 240 transmits, or provides, the measured required time to print the test patterns per each object printed by the print part 230, via the host interface part 220, to the host device 100 (operation S420). In response to receiving the print data, via the host interface part 220, from the host device 100 (operation S430-YES), the control part 240 controls the print part 230 to print the print data. The print part 230 outputs the print data having only objects with a fast printing speed (operation S440).

The operations of the printing method of the image forming device 200 illustrated in FIG. 5 are performed by each of the plurality of image forming devices 200, such as image forming devices 200a through 200c, illustrated in FIG. 1. However, only the image forming apparatus 200, which is selected among the plurality of image forming devices 200a through 200c to perform an actual printing by the host device 100, typically performs the operation S440. In this regard and by way of example, if the print data is not received in operation S430 (S430-NO), the operation S440 is not performed since the image forming device 200 is not selected to perform an actual printing by the host device 100.

As described above, a host device, an image forming device, and a printing control method are provided according to aspects of the invention. According to aspects of the invention, the host device selects one among the plurality of image forming devices that can perform the print data with a fastest speed, and processes the print data with objects with a fast, or relatively faster, printing speed by the selected image forming device, wherein an improvement in the printing speed, such as to provide a relatively faster printing speed to print the print data, can be promoted.

The foregoing embodiments and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A host device to control printing of an image forming device, comprising:
an application program part to provide a print command on print data;
an image forming device interface part to provide an interface with the image forming device;
a driver part to request of the image forming device a required time to print a test pattern per each object, via the image forming device interface part, to compare the required time to print the test pattern per each object with a pre-set reference time, and to determine each object to be changed to another object as a determined object included in the print data based upon the required time to print the test pattern per each object compared to the pre-set reference time; and
an object change part to change each determined object to another object that requires less time to print than the pre-set reference time,
wherein the driver part produces the print data based on each changed object or each unchanged object or both the changed and unchanged objects of the print data to transmit, via the image forming device interface part, to the image forming device.

2. The host device as claimed in claim 1, wherein:
the pre-set reference time is set according to one or more of a reference speed of the image forming device, a degree of complication of the test pattern per each object, or a data capacity of the test pattern per each object.

3. The host device as claimed in claim 1, wherein:
the driver part also transmits the test pattern per each object, via the image forming device interface part, to the image forming device, where requesting a required time to print the test pattern per each object.

4. The host device as claimed in claim 1, wherein:
the object change part comprises a Windows graphic device interface (GDI).

5. A printing control method of an image forming device, comprising:
requesting of the image forming device a required time to print a test pattern per each object where a print command is provided on print data;
receiving the required time to print the test pattern per each object from the image forming device;
comparing the received required time to print the test pattern per each object with a pre-set reference time to determine an object to be changed to another object as a determined object included in the print data based upon the required time to print the test pattern per each object compared to the pre-set reference time;
changing each determined object to be changed to another object that requires less time to print than the pre-set reference time; and
producing the print data based on each changed object or each unchanged object or both the changed and unchanged objects of the print data to transmit to the image forming device.

6. The printing control method as claimed in claim 5, further comprising:
setting the pre-set reference time according to one or more of a reference speed of the image forming device, a degree of complication of the test pattern per each object, or a data capacity of the test pattern per each object.

7. The printing control method as claimed in claim 5, wherein:
the requesting the required time to print the test pattern per each object includes also transmitting the test pattern per each object to the image forming device.

8. An image forming device, comprising:
a host interface part to receive a request signal to request a required time to print a test pattern per each object from a host;
a print part to print the test pattern per each object; and
a control part to measure the required time to print the test pattern per each object by the print part and to control the host interface part to transmit the measured required time to print the test pattern per each object to the host.

9. The image forming device as claimed in claim 8, further comprising:
a storage part to store the test pattern per each object.

10. The image forming device as claimed in claim 8, wherein:
the host interface part receives the test pattern per each object together with the request signal to request the required time to print the test pattern per each object.

11. A host device to control printing of a plurality of image forming devices, comprising:
an application program part to provide a print command on print data;
an image forming device interface part to provide an interface with the plurality of the image forming devices;
a driver part to recognize a component ratio per each object included in the print data, to determine an expected processing time of the print data for each of the plurality of image forming devices corresponding to a required time to print test patterns per each object of the plurality of image forming devices, to select one of the plurality of image forming devices that has the shortest expected processing time, and to compare the required time to print the test pattern per each object with a pre-set reference time to determine each object to be changed to another object as a determined object included in the print data based upon the required time to print the test pattern per each object compared to the pre-set reference time; and
an object change part to change each determined object to another object that requires less time to print than the pre-set reference time,
wherein the driver part produces the print data based on each changed object or each unchanged object or both the changed and unchanged objects of the print data to transmit, via the image forming device interface part, to the selected image forming device.

12. The host device as claimed in claim 11, wherein
the driver part transmits the test patterns per each object, via the image forming device interface part, to the plurality of the image forming devices, and receives the required time to print the test patterns per each object from the plurality of the image forming devices.

13. The host device as claimed in claim 12, further comprising:
a storage part to store a table regarding a required time to print the test patterns per each object of the plurality of image forming devices,
wherein the driver part updates the table of the storage part by the received required time to print the test patterns per each object.

14. The host device as claimed in claim 11, wherein
the pre-set reference time is set according to one or more of a reference speed of the image forming device, a degree of complication of the test pattern per each object, or a data capacity of the test pattern per each object.

15. The host device as claimed in claim 11, wherein:
the object change part comprises a Windows graphic device interface (GDI).

16. A printing method of a plurality of image forming devices, comprising:
recognizing a component ratio per each object included in print data where a print command is provided on the print data;
determining an expected processing time of the print data for each of the plurality of image forming devices corresponding to a required time to print test patterns per each object of the plurality of image forming devices;
selecting one of the plurality of image forming devices that has the shortest expected processing time;
comparing the required time to print the test pattern per each object with a pre-set reference time to determine each object to be changed to another object as a determined object included in the print data based upon the required time to print the test pattern per each object compared to the pre-set reference time;
changing each determined object to another object that requires less time to print than the pre-set reference time; and
producing the print data based on each changed object or each unchanged object or both the changed and unchanged objects of the print data to transmit to the selected image forming device.

17. The printing method as claimed in claim 16, further comprising:
transmitting the test patterns per each object to the plurality of the image forming devices; and
receiving the required time to print the test patterns per each object from the plurality of the image forming devices.

18. The printing method as claimed in claim 17, further comprising:
storing the received required time to print the test patterns per each object into a table regarding the required time to print the test patterns per each object from the plurality of the image forming devices.

19. The printing method as claimed in claim 18, further comprising:
setting the pre-set reference time according to one or more of a reference speed of the image forming device, a degree of complication of the test pattern per each object, or a data capacity of the test pattern per each object.

20. The printing method as claimed in claim 17, further comprising:
setting the pre-set reference time according to one or more of a reference speed of the image forming device, a degree of complication of the test pattern per each object, or a data capacity of the test pattern per each object.

21. The printing method as claimed in claim 16, further comprising:
setting the pre-set reference time according to one or more of a reference speed of the image forming device, a degree of complication of the test pattern per each object, or a data capacity of the test pattern per each object.

22. The host device as claimed in claim 12, wherein
the pre-set reference time is set according to one or more of a reference speed of the image forming device, a degree of complication of the test pattern per each object, or a data capacity of the test pattern per each object.

23. The host device as claimed in claim 22, wherein:
the object change part comprises a Windows graphic device interface (GDI).

24. A printing method of an image forming device, comprising:
determining a required time to print a test pattern per each object included in print data;
comparing the required time to print the test pattern per each object with a predetermined reference time to determine each object to be changed to another object as a determined object included in the print data based upon the required time to print the test pattern per each object compared to the predetermined reference time; and
changing each determined object, as a result of the comparison, to another object that requires less time to print than the predetermined reference time.

25. The printing method according to claim 24, further comprising:
producing the print data by the image forming device based on each changed object or each unchanged object or both the changed and unchanged objects included in the print data.

26. A printing system, comprising:
a host device to compare a required time to print a test pattern per each object included in print data with a predetermined reference time, to determine each object to be changed to another object as a determined object included in the print data based upon the required time to print the test pattern per each object compared to the predetermined reference time, and to change each determined object to another object that requires less time to print than the predetermined reference time; and
an image forming device to print a test pattern per each object in the print data, to measure the required time to print the test pattern per each object, and to provide the required time to print the test pattern per each object to the host device.

27. The printing system according to claim 26, wherein:
the host device produces the print data based on each changed object or each unchanged object or both the changed and unchanged objects of the print data to transmit to the image forming device.
